(19) United States
(12) Patent Application Publication
(10) Pub. No.: US 2014/0000085 A1
(43) Pub. Date: Jan. 2, 2014

(54) REMOVAL TOOL AND METHOD FOR PHOTOVOLTAIC FASTENER

(71) Applicants: William Teller, Lake Orion, MI (US); Brian C. Cheung, San Francisco, CA (US); Luc DuPont, Lans-en-Vercors (FR); Elio G. Evangelista, Chesterfield, MI (US); Dorian J. Kilgore, Southfield, MI (US)

(72) Inventors: William Teller, Lake Orion, MI (US); Brian C. Cheung, San Francisco, CA (US); Luc DuPont, Lans-en-Vercors (FR); Elio G. Evangelista, Chesterfield, MI (US); Dorian J. Kilgore, Southfield, MI (US)

(73) Assignee: A. Raymond et Cie, Grenoble (FR)

(21) Appl. No.: 13/539,768

(22) Filed: Jul. 2, 2012

(51) Int. Cl. B23P 11/00; B25B 27/14; B25B 7/00

(52) U.S. Cl. 29/426.6; 29/267; 29/268

(57) ABSTRACT

A tool for use with a fastener is provided. Another aspect employs a removal tool for use with a photovoltaic fastener. In one aspect, a photovoltaic frame attachment apparatus includes a photovoltaic module including a peripheral frame, a strut or rail and a snap-in clip or fastener. In another aspect, a single-piece fastener includes at least one flexible wing matable with an opening in a strut, a flexible tongue internally projecting in a central manner from a top wall of a body, and a slot adapted to receive a portion of a photovoltaic panel frame. In a further aspect, a tool is rotated to disengage a central tongue of a fastener from a photovoltaic frame. Yet another aspect employs a tool to compress a finger and/or wing to allow fastener removal from a strut.

### BACKGROUND AND SUMMARY

The present disclosure relates generally to a tool and more particularly to a removal tool and method for a photovoltaic fastener.

Traditionally, peripheral mounting frames holding solar or photovoltaic panels are mounted to a supporting structure on a building roof or on the land through use of threaded fasteners and multi-piece brackets. Exemplary traditional devices are disclosed in U.S. Pat. No. 7,758,011 entitled “Adjustable Mounting Assembly for Standing Seam Panels” which issued to Haddock on Jul. 20, 2010, and U.S. Pat. No. 6,105,317 entitled “Mounting System For Installing an Array of Solar Battery Modules of a Panel-Like Configuration on a Roof” which issued to Tomiuchi et al. on Aug. 22, 2000. These patents are incorporated by reference herein. These devices, however, have many loose parts, and are time consuming and complex to install on a job site, such as on top of a windy roof, which thereby incurs significant labor expense and effort.

Another solar panel module fastener is disclosed in German Patent Publication No. 10 2010 022 556 by Klaus Hullmann et al. A fastener removal tool, useable from above the solar panels and having ends inserted into a rail opening, is also disclosed. While this fastener and tool are noteworthy advances in the industry, further improvements are desirable.

In accordance with the present invention, a tool for use with a fastener is provided. Another aspect employs a removal tool for use with a photovoltaic fastener. In one aspect, a photovoltaic frame attachment apparatus includes a photovoltaic module including a peripheral frame, a strut or rail and a snap-in clip or fastener. In another aspect, a single-piece fastener includes at least one flexible wing matable with an opening in a strut, a flexible tongue internally projecting in a central manner from a top wall of a body, and a slot adapted to receive a portion of a photovoltaic panel frame. In a further aspect, a tool is rotated to disengage a central tongue of a fastener from a photovoltaic frame. Yet another aspect employs a tool to compress a finger and/or wing to allow fastener removal from a strut. Moreover, methods of removing a photovoltaic frame fastener from a strut, and a photovoltaic frame from a fastener, are also provided.

The present photovoltaic fastener removal tools and methods are advantageous over traditional devices. For example, the present tools and methods are inexpensive, fast, and require minimal forces. Furthermore, the present apparatus does not require many loose parts which are difficult to handle on a windy building roof or in a field. Moreover, the present tools and methods easily allow part removal for a system which advantageously hides snap-in wing sections securing a frame and strut, thereby making theft and vandalism difficult. For an upper tool, fastener construction and method allow standard tools to be used for frame removal. For a lower tool, a fastener can be accessed outside of a strut even when photovoltaic modules are still attached, and without requiring blind insertion of the tool into the strut. In one embodiment, a locking feature of a lower tool frees up the service person's hands during fastener removal. Additional advantages and features of the present invention will become apparent from the following description and appended claims taken in conjunction with the accompanying drawings.

### BRIEF DESCRIPTION OF THE DRAWINGS

FIG. 1 is a perspective view showing a photovoltaic frame fastener assembly mounted to a building roof;

FIG. 2 is a perspective view showing a photovoltaic frame fastener assembly mounted to the ground;

FIG. 3 is an exploded perspective view showing a first preferred embodiment of a photovoltaic frame fastener assembly;

FIG. 4 is a perspective view showing the first embodiment photovoltaic frame fastener assembly;

FIG. 5 is a perspective view showing the first embodiment photovoltaic frame fastener assembly, taken opposite that of FIG. 4;

FIG. 6 is a perspective view like that of FIG. 5, showing the first embodiment photovoltaic frame fastener assembly, without a strut;

FIG. 7 is a perspective view like that of FIG. 6, showing the first embodiment photovoltaic frame fastener assembly, with an upper removal tool;

FIG. 8 is a top elevational view showing the first embodiment photovoltaic frame fastener assembly, with the upper removal tool;

FIG. 9 is a side elevational view showing one embodiment of a lower removal tool used with the photovoltaic frame fastener assembly;

FIG. 10 is a top elevational view showing a second embodiment of the lower removal tool used with the photovoltaic frame fastener assembly;

FIG. 11 is a side elevational view showing the lower removal tool of FIG. 10;

FIG. 12 is a top elevational view showing the lower removal tool engaging the first embodiment fastener;

FIG. 13 is a perspective view showing the lower removal tool engaging the first embodiment fastener;

FIG. 14 is an end elevational view showing the lower removal tool initially contacting a second embodiment of a photovoltaic frame fastener;

FIG. 15 is an end elevational view like that of FIG. 14, showing the lower removal tool inwardly compressing wings of the first embodiment fastener;

FIG. 16 is a side elevational view showing the second embodiment photovoltaic frame fastener assembly;

FIG. 17 is an end elevational view showing the second embodiment photovoltaic frame fastener assembly;

FIG. 18 is a perspective view showing the second embodiment photovoltaic frame fastener;

FIG. 19 is a perspective view, taken opposite that of FIG. 18, showing the second embodiment photovoltaic frame fastener;

FIG. 20 is a top elevational view showing the second embodiment photovoltaic frame fastener;

FIG. 21 is an end elevational view showing the second embodiment photovoltaic frame fastener;

FIG. 22 is a side elevational view showing the second embodiment photovoltaic frame fastener;

FIG. 23 is a cross-sectional view, taken along lines 23-23 of FIG. 22, showing the second embodiment photovoltaic frame fastener;

FIG. 24 is a top elevational view showing a flat blank used to create the second embodiment photovoltaic frame fastener;

FIG. 25 is a top elevational view showing the upper and lower removal tools used with the second embodiment photovoltaic frame fastener assembly;

FIG. 26 is a perspective view showing a third embodiment photovoltaic frame fastener assembly;

FIG. 27 is an end elevational view showing the third embodiment photovoltaic frame fastener;

FIG. 28 is a perspective view showing a third embodiment of a lower removal tool, used with the third embodiment photovoltaic frame fastener assembly;

FIG. 29 is an end elevational view showing the third embodiment lower removal tool and third embodiment photovoltaic frame fastener assembly in a fully compressed condition; and

FIG. 30 is a perspective view showing the third embodiment lower removal tool and first embodiment fastener.

### DETAILED DESCRIPTION

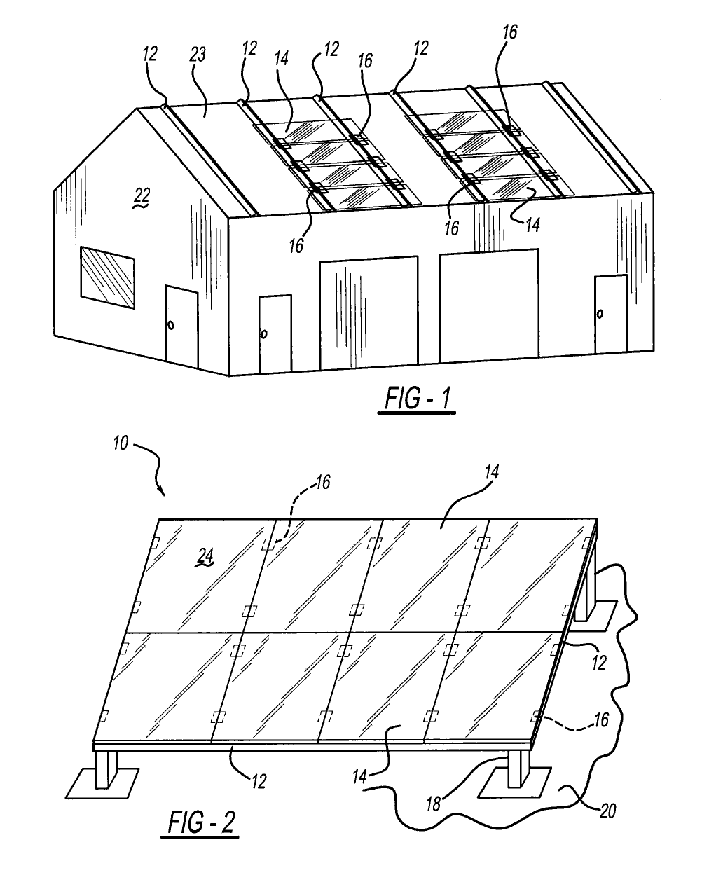

Referring to FIGS. 1-3, a first embodiment of a photovoltaic frame fastener assembly 10 includes elongated and rigid rails or struts 12, solar or photovoltaic panel modules 14, and fasteners 16. Struts 12 are mounted to vertical legs 18 attached to land or ground 20 in one configuration. In another configuration, struts 12 are bolted onto a roof clamp or other structure on a roof or side of a building 22. Each photovoltaic module 14 includes a chemically coated glass photovoltaic panel 24 and an adhesively attached, peripheral metallic frame 26. Glass photovoltaic panel 24 and metallic frame 26 are provided as a pre-assembled unit or may be provided as separate units to the installation site.

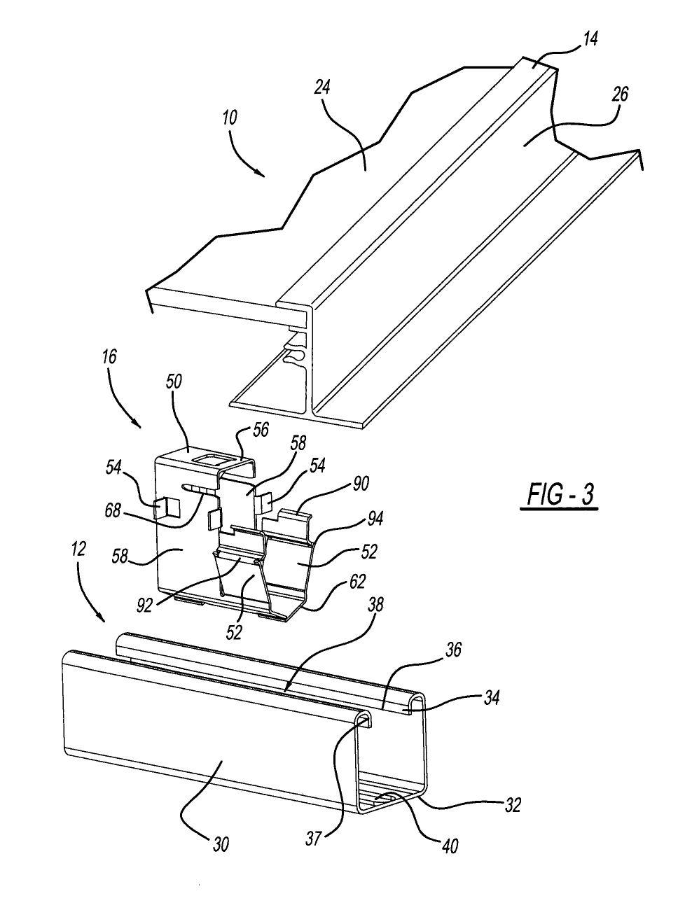

As best shown in FIGS. 3-5 and 8, strut 12 has a uniform and generally U-shaped cross-section as defined by upstanding sidewalls 30 joined by a bottom wall 32. A reverse-turned wall 34 extends from a top end of each sidewall 30 and terminates in a downwardly directed edge 36. Downwardly directed edge 36 provides a folded-over region of upstanding sidewalls 30 and as detailed below provide attachment points for wings of fasteners 16. An elongated channel or opening 38 is defined between reverse turn walls 34. Optional mounting holes 40 are provided in bottom wall 32 to allow for securing of strut 12 to a building attachment, bolt upwardly projecting from a standing seam roof clamp, or ground-based support. Strut 12 is stamped or rolled from aluminum or steel.

Referring now to FIGS. 3-6, fastener 16 includes a body 50, a pair of flexible wings 52, and four rigid tabs 54. Body 50 includes a top wall 56, a pair of spaced apart side walls 58 and tapered lead-in walls 60. The walls of body 50 and wings 52 define peripheral edges 62 that allow for hollow open access at ends thereof. Furthermore, lead-in walls 60 cross and overlap each other adjacent distal edges thereof. A pair of aligned and elongated openings or slots 68 are disposed in an upper area of body 50 above at least some of tabs 54. Each slot 68 has an openly accessible end and they both receive a flat segment of metallic frame 26 inserted therein to secure photovoltaic module 14 to fastener 16.

A flexible tongue member 80 is downwardly and diagonally bent from an inside of top wall 56 of fastener 16. A distal edge of tongue 80 includes multiple, preferably two, generally pointed formations 82 separated by a recess or valley 84. Formations 82 gouge or score into a top surface of frame 26 to secure frame 26 within slots 68 of fastener 16. The diagonal and flexible nature of tongue 80 allows for low effort installation of frame 26 into slots 68 but significantly greater (at least four times) removal force. Tongue 80 is centrally inboard of all peripheral fastener edges 62 adjacent to a central hole 86 in top wall 56.

An inwardly curved finger 90 upwardly projects from a top section of each wing 52. Finger 90 has a smaller width (the width being in the elongated direction of strut 12) than does the adjacent wing 52. Each wing 52 further has an offset angled step 92 at an apex, defining a thickness dimension of the collective wings. Barbs or outwardly and localized arms 94 are located on the lateral edges adjacent each step 92 to more securly engage downturned edges 36 of strut.

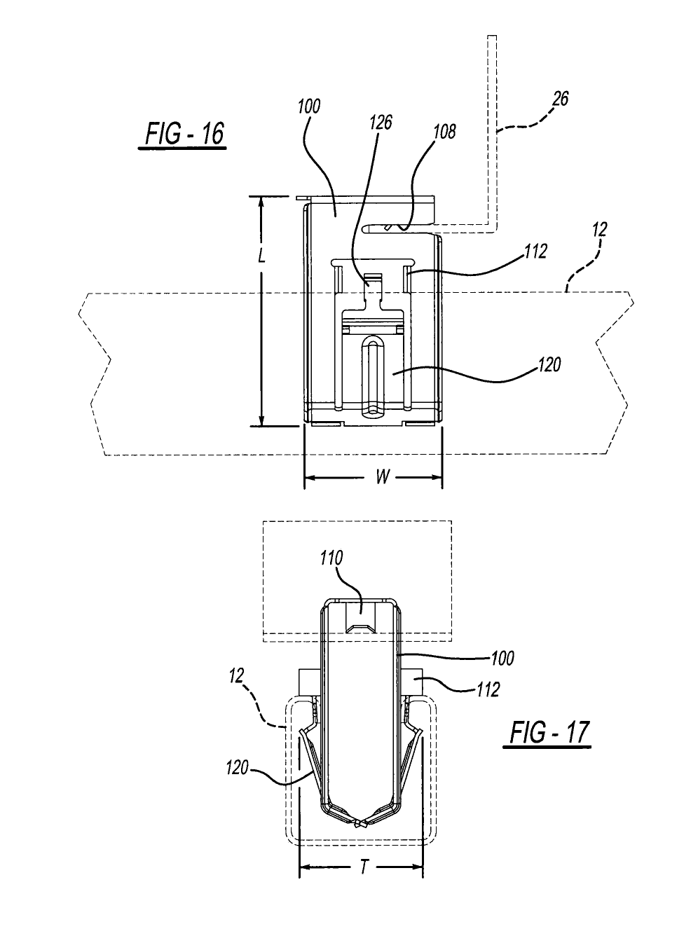

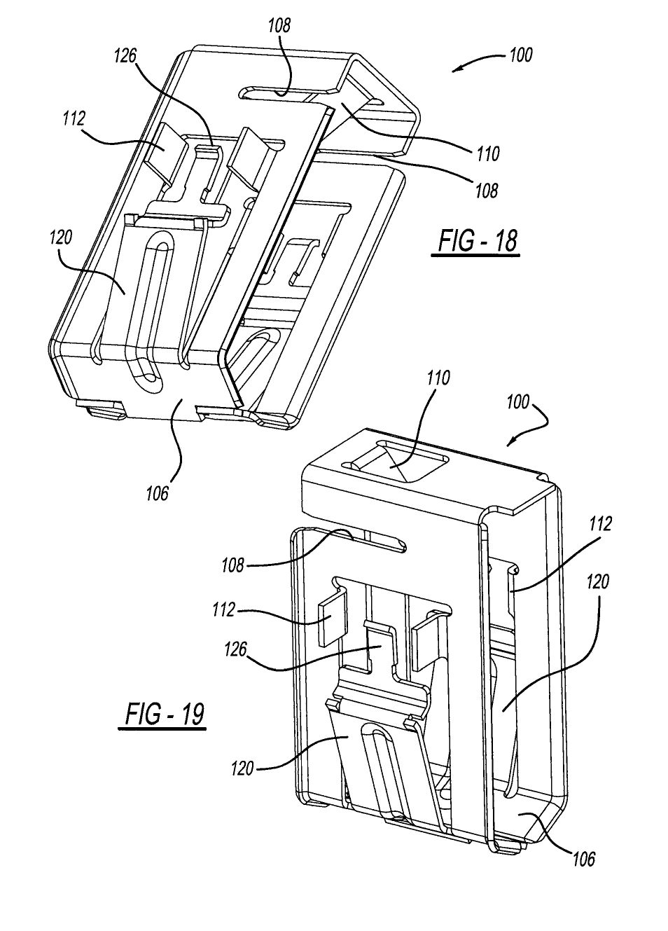

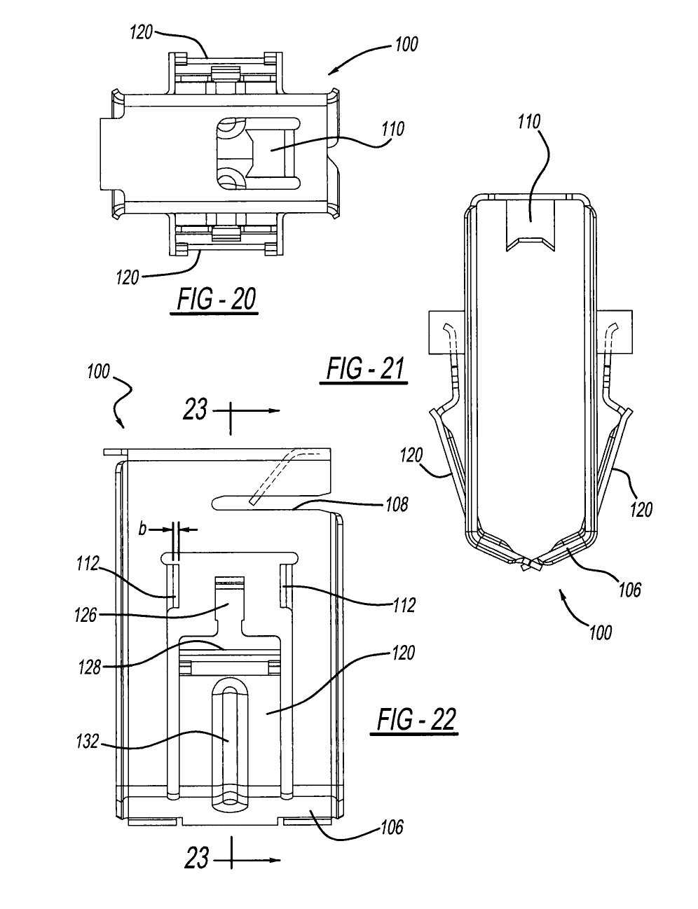

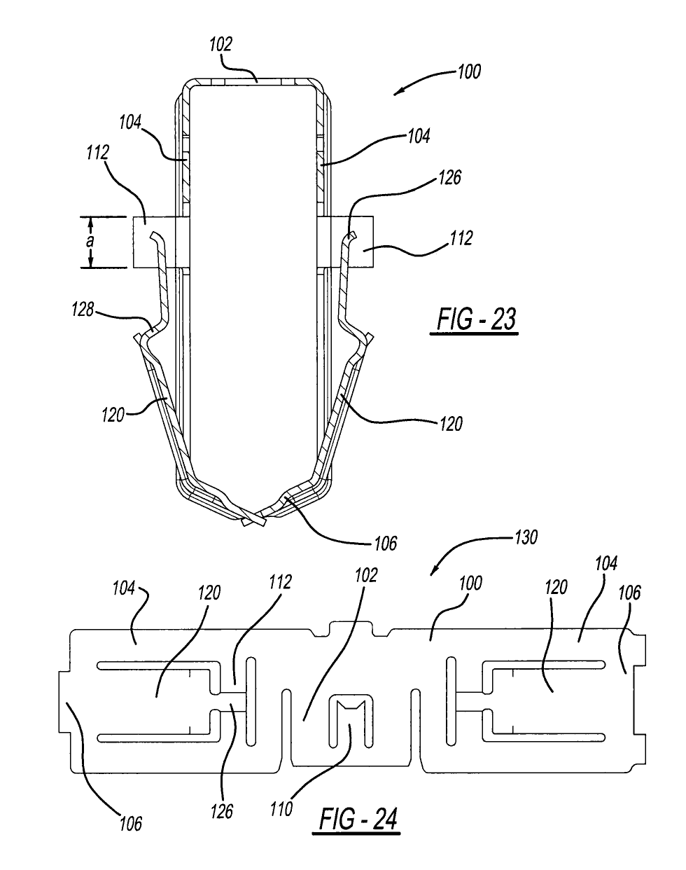

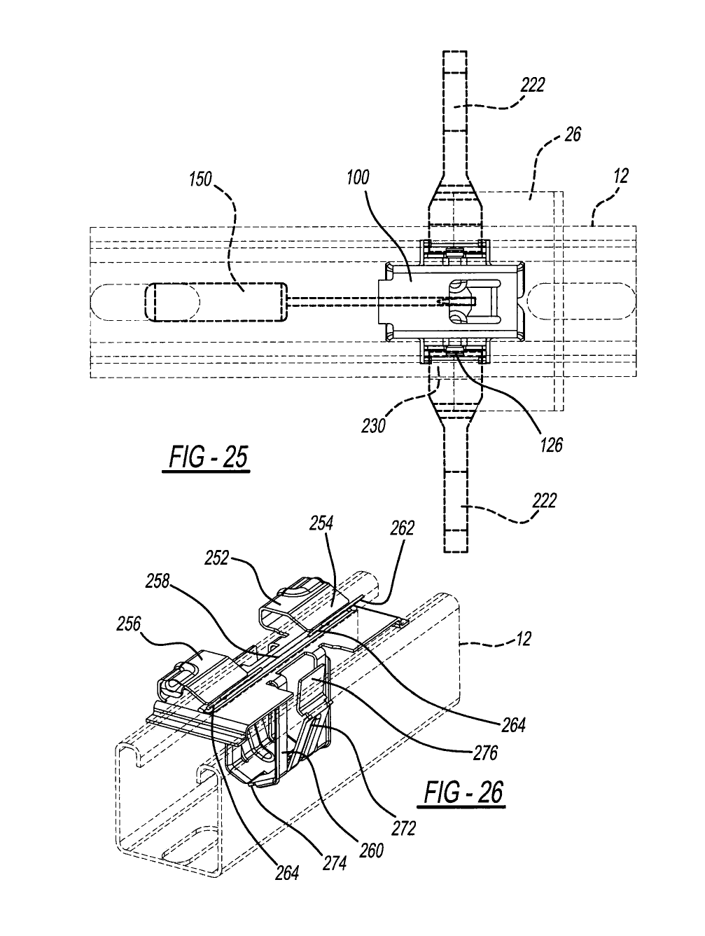

Reference should now be made to FIGS. 16-24 which show another embodiment of a photovoltaic frame fastener 100 of the present invention. Fastener 100 includes a top wall 102, side walls 104 and tapered lead-in walls 106 like with the prior embodiment fastener 16. Furthermore, a frame receiving slot 108 is located within each side wall 104 and a flexible and bifurcated tongue 110 is downwardly bent from top wall 102 like with the prior embodiment. At least two, and more preferably four, rigid tabs 112 outwardly extend in a generally parallel manner to each other and perpendicular from each associated side wall 104. Tabs 112, like with the prior embodiment, abut against an outside surface of strut 12 adjacent the opening therein, to deter tilting of the fastener and also to prevent over-insertion of the fastener too far into the strut during installation. Each tab 112 has a greater longitudinal dimension a than a width dimension b, in order to increase the longitudinal rigidity and stiffness of the tab.

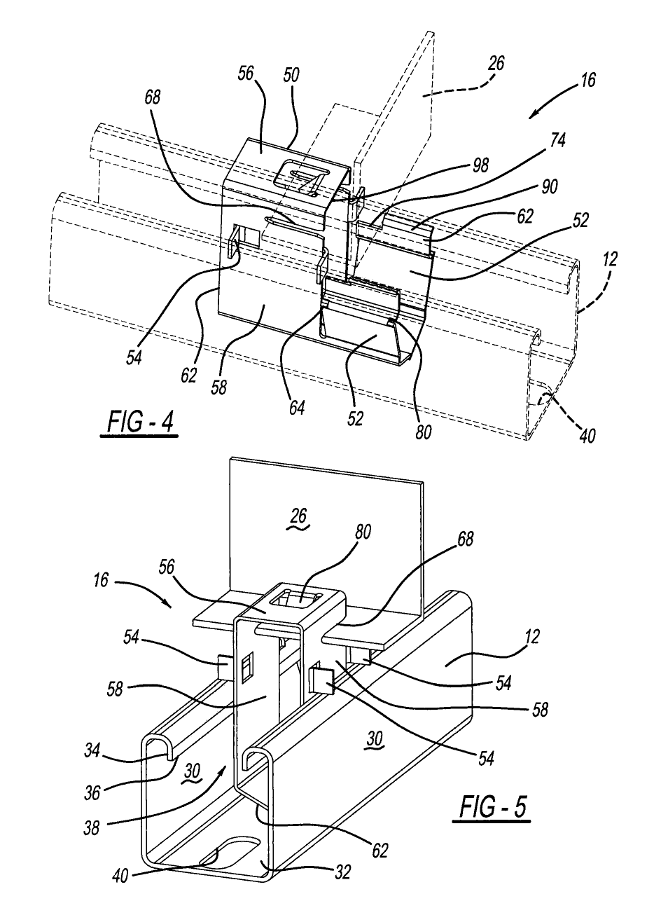

Different than the prior embodiment, the present fastener 100 has a pair of flexible wings 120 which are outwardly bent from side walls 104 adjacent lead-in walls 106, but longitudinally directly below slots 108. This alignment advantageously reduces undesired torque imparted on fastener 100 due to a lateral offset of slots 68 (see FIG. 4) versus wings 52 of the prior embodiment fastener. Additionally, the present fastener 100 is more compact and the wings 120 are better hidden by the attached solar panel module and frame 26 thereabove. For example, a longitudinal dimension L is greater than both a width W and a total nominal thickness T, for this embodiment.

A finger 126 centrally extends from an upper edge of each wing 120 generally between a pair of adjacent tabs 112. Each finger 126 has an outwardly curved distal end opposite the corresponding step 128 of each wing. Moreover, finger 126 has a smaller lateral width as compared to adjacent wing 120 in order to allow for material size savings of a sheet metal blank 130 from which fastener 100 is stamped and bent as a single, metallic piece. A stiffening rib or bead 132 is also provided along a generally flat outwardly angled section of each wing 120 to provide compressive strength to resist inadvertent disassembly from strut 12 after the wings have been snapped into engagement with return edge of the strut during assembly. Fastener 100 resists at least 100 pounds of pullout force from strut 12 without destruction.

When fully installed, the solar panel module hides a majority of each fastener 16 and 100. This feature advantageously deters theft of the solar panel module 14 by making it less clear to a casual observer that compression together of the wings will allow detachment of the fastener from strut 12. Fasteners 16 and 100 are preferably stamped from a Magni coated and austemper heat treated spring steel of type SAE 1050-1065, with a finish hardness of 44-51 Rc, and a sheet thickness of 1.0 nm, but alternately may be stamped from stainless steel.

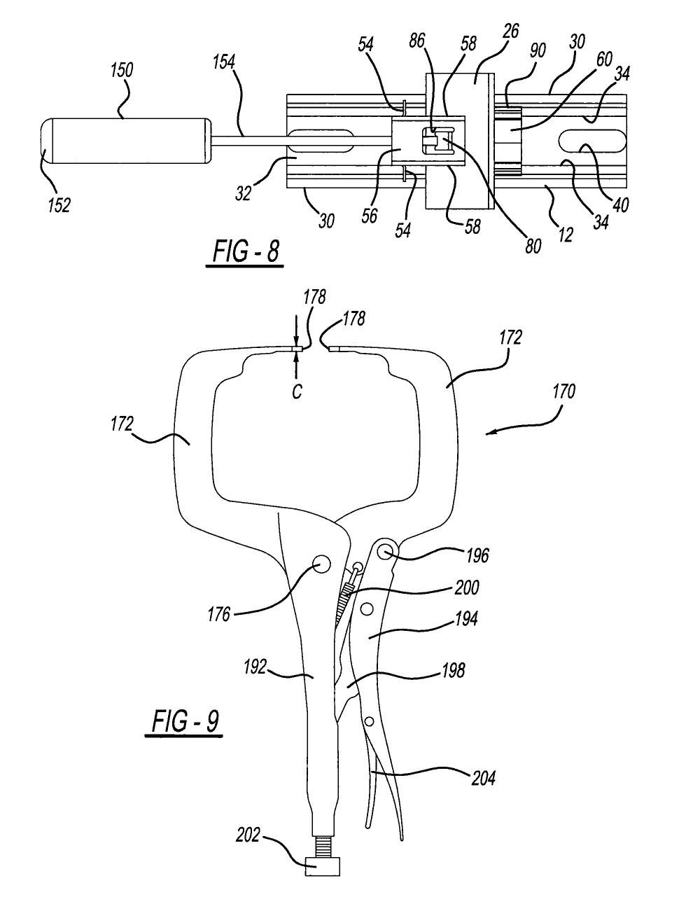

FIGS. 7 and 8 illustrate an upper removal tool 150 used to disengage photovoltaic frame 26 from either fastener 16 or 100. Exemplary fastener 16 will be referenced hereinafter although it should be appreciated that any of the removal tools can be used for either of the fasteners.

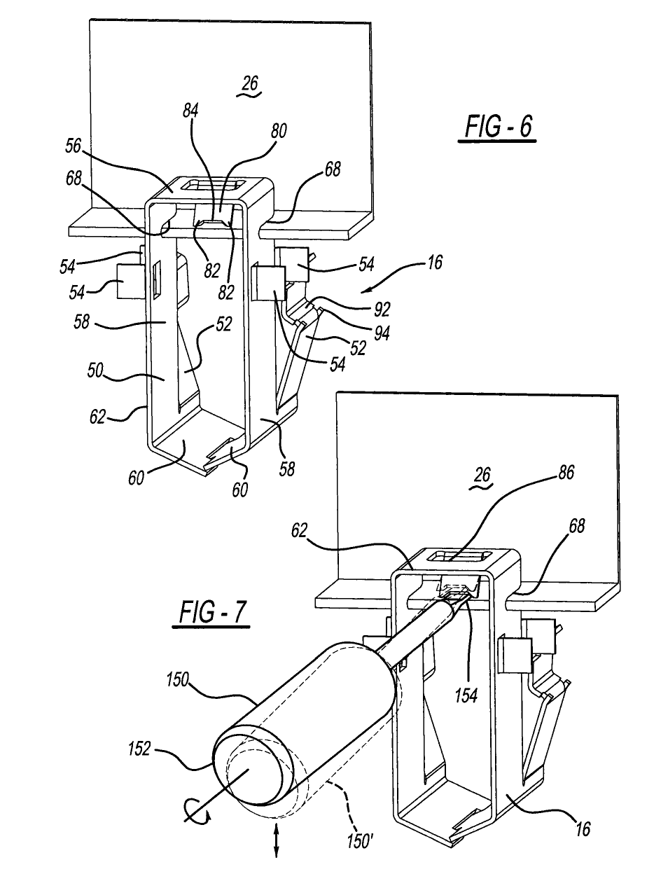

Upper removal tool 150 is preferably a screwdriver having an enlarged handle 152, an enlongated rigid shaft 154 and a flat blade 154. The construction or service person initially inserts screwdriver tool 150 in a linear and lateral direction into the hollow opening of fastener 16 between the side walls and below the glass solar module. This may be either done from below the assembly as space allows, or after the fastener is removed from the strut as will be described in further detail hereinafter. Blade 154 is linearly and horizontally inserted between valley 84 (see FIG. 6) and the segment of frame 26 that is within slots 68. Thereafter, the construction person rotates tool 150 by either linearly pushing down to the position 150′ or by rotating the tool about is centerline, thereby providing leverage to push the tongue 80 and associated pointed formations 82 upwardly and away from the adjacent segment of frame 26. Concurrently or subsequently, the construction person linearly pulls frame 26 out of slots 68 since tongue 80 is no longer deterring removal thereof. The torsion upon tool 150 will then cease and the tool removed. It should be appreciated that other lever type tools can be employed as long as they can impart the same tongue flexure during frame removal, preferably without over-flexing or damaging either the fastener or frame, so that they can be reused if desired.

A first embodiment of a lower removal tool 170 is shown in FIG. 9. This tool has a pair of generally C-shaped jaws 172 which are spaced apart from each other by at least three inches to create a large central void 174. The proximal ends of jaws 172 are coupled together by way of one or more pivots 176. An opposite distal end of each jaw 172 has a generally flattened and straight tip 178. Furthermore, the thickness C of each tip 178 is less than one-quarter of that for the nominal central portion of each jaw 172.

A primary handle 192 is integrally formed as part of one jaw 172. A separate auxiliary handle 194 is coupled to the other jaw 172 via one or more pivots 196. A camming link 198 pivotally couples the handles together as does a biasing spring 200. An adjustment screw 202 is threadably received within primary handle 192 for setting the adjusted position of camming link 198. Additionally, a release handle 204 is pivotally coupled to handle 194 for releasing a clamped and locked state of tool 170. The handle and locking mechanism work in accordance with U.S. Pat. No. 8,056,451 entitled “Locking Pliers” which issued to Chervenak et al. on Nov. 15, 2011, which is incorporated by reference herein. This tool embodiment can be used from below the fastener and strut as further discussed hereinafter, or is well suited for engaging laterally offset wings 52 (see FIG. 3) of fastener 16 from above and between adjacent photovoltaic panel modules 14.

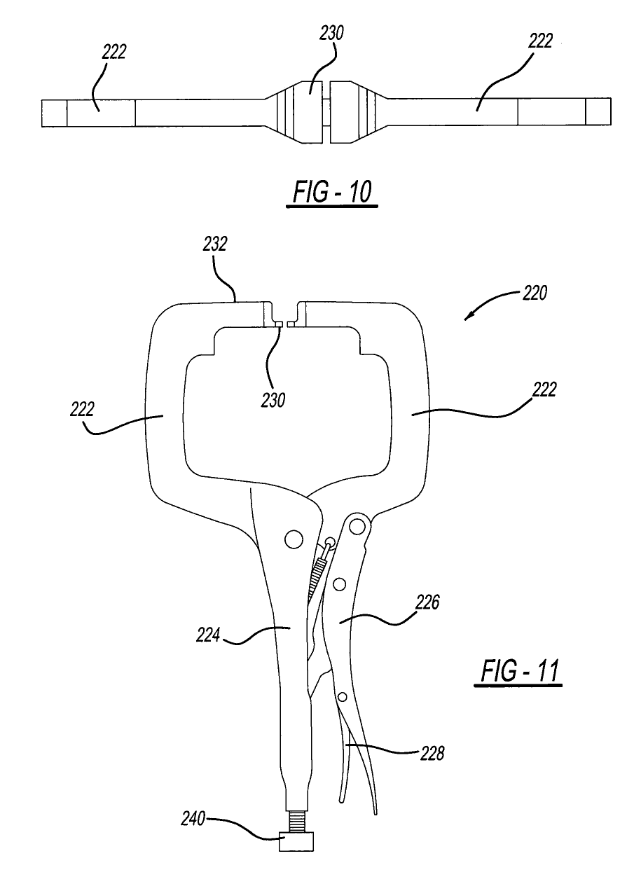

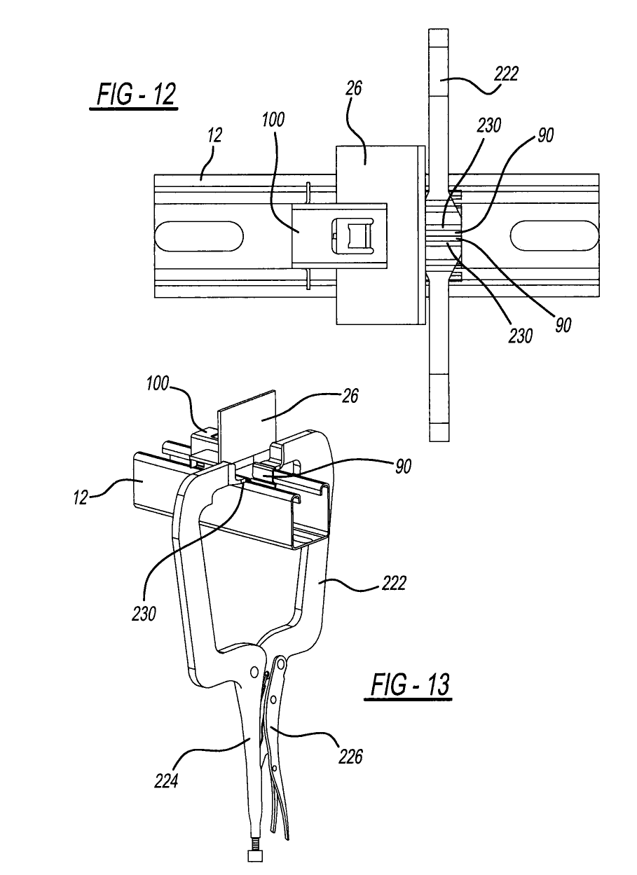

A second embodiment lower removal tool 220 is shown in FIGS. 10 and 11. This tool has a pair of spaced apart jaws 222 and handles 224, 226 and 228, like that of the prior embodiment. A locking, adjustment and release mechanism are also similarly provided. However, tips 230 are downwardly stepped from an upper surface 232 of each jaw, which is opposite that of the prior embodiment. Either embodiment lower tool 170 or 220 can be used for removal of the fastener, but only the second embodiment lower tool 220 will be discussed hereinafter by way of example.

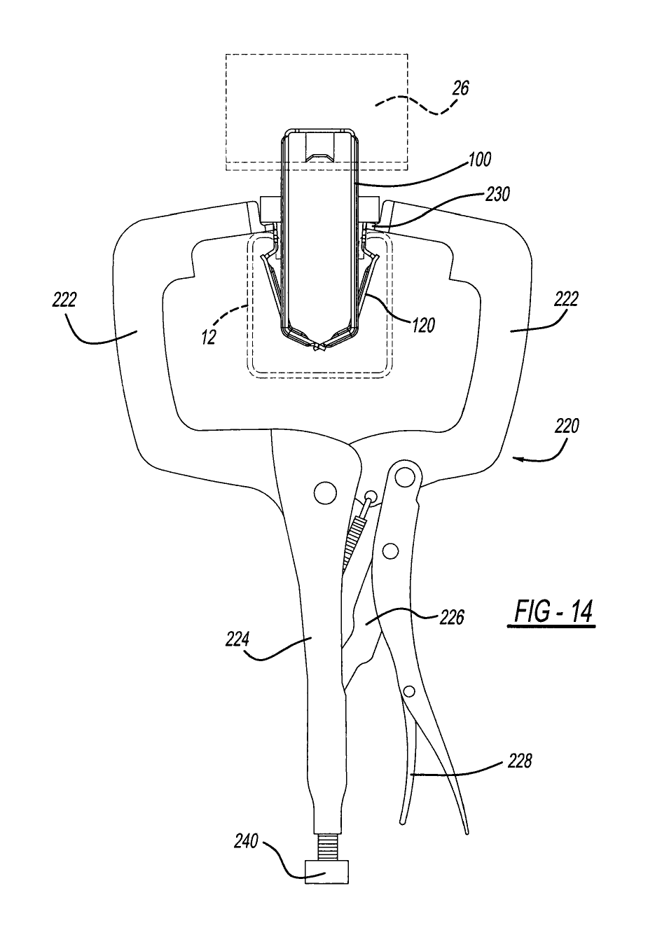

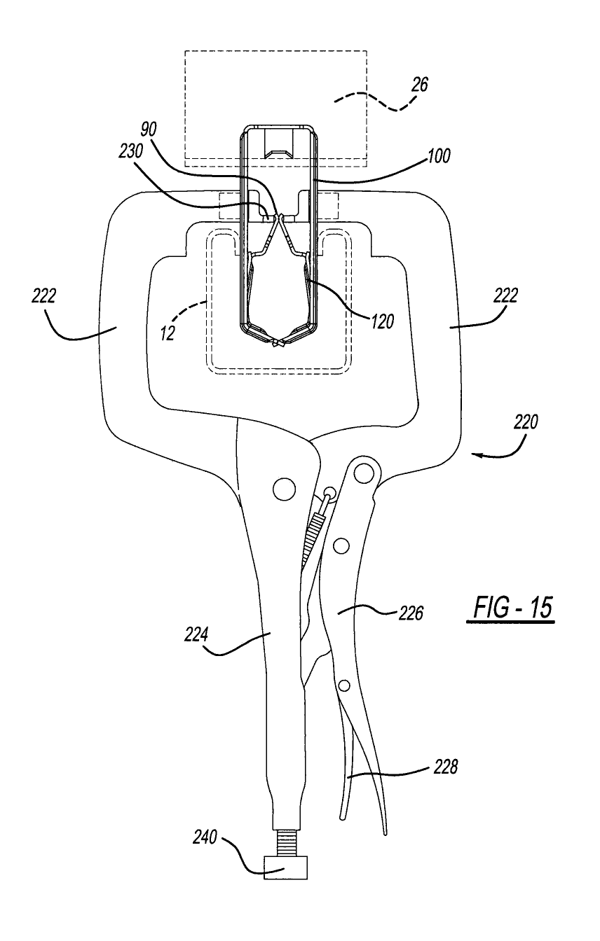

The construction or service person initially approaches fastener 100 (by way of non-limiting example) from below strut 12. The person thereafter essentially surrounds a cross-section of strut 12 by jaws 222 as tips 230 make initial contact with fingers 126 (as can best be observed in FIGS. 14 and 16) accessible above the upper surface of strut 12. Next, the construction person fully squeezes together handles 224 and 226 such that the camming link will put the tool in a locking and fully clamped position, which causes tips 230 of tool 220 to be in their fully compressed position (as adjusted by adjustment screw 240). Consequently, tips 230 inwardly compress fingers 126 and the attached wings 120 toward each other and the fastener centerline, such that the wings can thereafter be longitudinally and linearly pulled free of strut 12 through the upper opening therein while staying engaged by tool 220. After full removal, release handle 228 is pulled toward auxiliary handle 226 to release the locking mechanism and thereby disengage tool 220 from fastener 100.

It is noteworthy that no portion of the tool needs to be inserted into the strut for fastener removal. Furthermore, the locking and unlocking feature of lower removal tool 220 is also advantageous by allowing for hands-free wing compression after the tool clamping position has been set; this is especially advantageous when many of these tools simultaneously engage and compress multiple fasteners for the same solar panel module whereafter the construction person can then use both of this hands for pulling up on the frame to remove all of the fasteners from the strut at the same time. Lower removal tool 220 is designed to not damage the fasteners such that they can be repeatedly reused. Moreover, the lower removal tools are preferably cast or stamped from steel, although other materials can be employed.

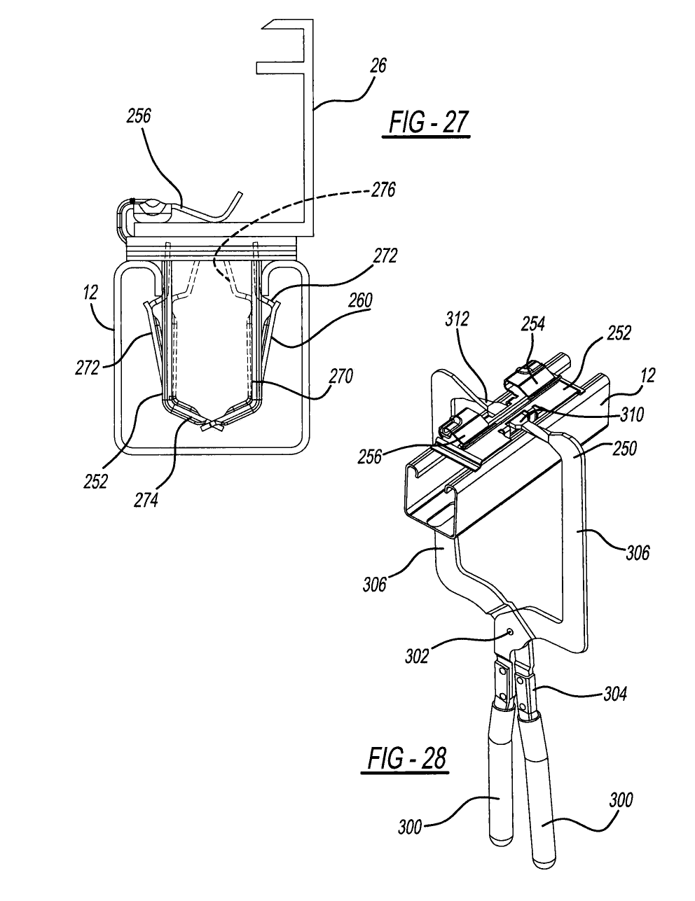

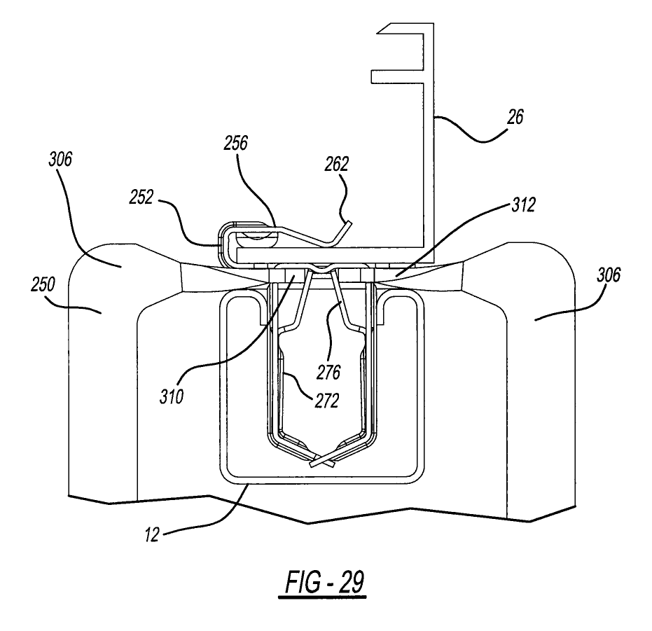

Referring now to FIGS. 26-29, a third embodiment of a lower removal tool 250 is used to remove a snap-in photovoltaic frame grounding clip 252. Grounding clip 252 includes a pair of spaced apart clamps 254 and 256, an upper bridge 258 and a mounting section 260. Each clamp has a generally C-shape, thereby creating an openly accessible receptacle therebetween. Furthermore, a lead-in wall 262 upwardly and outwardly angles away from each clamp to ease insertion of a flat lateral flange segment of frame 26 therein during assembly. If used for grounding, a pair of pointed barbs 264 internally project from each upper section of clamps 254 and 256. Each barb 264 cuts into and gouges the adjacent surface of frame 26 to scrape off the anodized coating thereat. This provides multiple satisfactory electrical grounding paths between the base material of the frame and the clip. This can be achieved by the simple linear insertion of the clamps of the clip onto the flange of the frame without the need for rotation or a threaded attachment. Alternately, the same fastener clip 252 can be used in a non-electrical grounding manner if barbs 264 are omitted.

Mounting section 260 includes side walls 270 and flexible wings 272. Each wing 272 is flexibly attached adjacent an inwardly tapered distal end 274 and is linearly snap-fit into the opening in strut 12 when installed. A finger 276 projects upwardly from each wing proud of strut. Furthermore, an offset step is located along a longitudinal length of each wing located closer to the finger than the distal end.

This embodiment removal tool 250 has a pair of generally cylindrical and longitudinally elongated handles 300 rotatably coupled together at pivot 302. A hinge 304 couples each handle 300 to a corresponding jaw 306. A flat and longitudinally thinner tip 310 laterally projects inward from each end of jaw 306 for contacting against and compressing upstanding fingers 276 from the expanded strut-engaging position to an inwardly compressed position 276′ whereafter the construction person can linearly remove fastener 252 from strut 12. Since jaws 306 are stamped from 1018 steel, a twist 312 is stamped between tips 310 and jaws 306. Lower removal tool 250 has a scissor handle and pivot arrangement to move jaws 306, but without a locking feature.

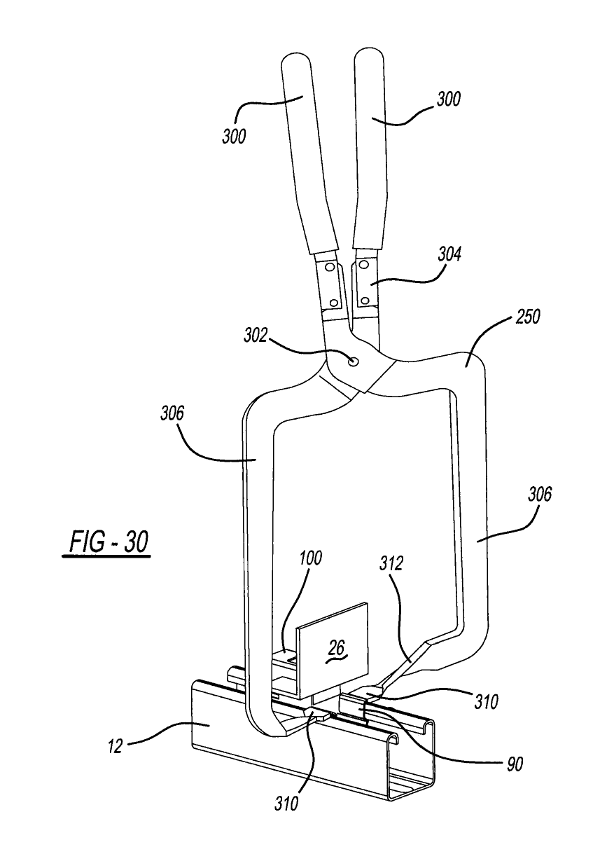

As illustrated in FIG. 30, this third embodiment lower removal tool 250 is also well suited for top down access within a gap between a pair of installed solar modules, including frames 26. Tips 310 then contact against and compress fingers 90 and their associated wings of the first embodiment fastener 100. This approach is easiest for a roof-mounted assembly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. Moreover, when the terms “top,” “bottom,” “upper,” “lower,” “side,” “end,” “above,” “below,” or the like are used, it is not intended to limit the orientation of the part since it is envisioned that the present apparatus can be inverted or positioned at many different orientations. The same may also be varied in many ways. Such variations are not to be regarded as a departure from the disclosure, and all such modifications are intended to be included within the scope and spirit of the present invention.

The invention claimed is:

1. A photovoltaic fastener removal apparatus comprising:
(a) a photovoltaic frame;
(b) a fastener comprising an opening within which a segment of the photovoltaic frame is located, and a flexible tongue securing the photovoltaic frame to the fastener; and
(c) a tool having a section removeably located between a portion of the tongue and the photovoltaic frame for prying the tongue away from the frame so the frame can thereafter be removed from the fastener.

2. The apparatus of claim 1, wherein the fastener further comprises an edge of the tongue including two substantially pointed formations spaced apart by a central valley, and the formations scoring the frame when engaged, and the tool being inserted between the formations during the prying.

3. The apparatux of claim 1, wherein the fastener further comprises a top wall spanning between spaced apart side walls, the tongue diagonally projecting downward between the side walls from the top wall, and the tool being inserted between the side walls to pry the tongue.

4. The apparatus of claim 1, further comprising:
an elongated structural strut having an opening and the fastener further comprising a flexible wing which snaps into engagement in the opening of the strut; and
a lower removal tool engaging a member associated with the wing to inwardly compress the wing and allow removal of the fastener from the strut, the member being accessible from outside the strut prior to removal of the fastener from the strut.

5. The apparatus of claim 1, wherein the tongue is entirely inwardly spaced from all external edges of the fastener, and the tool has an elongated shaft and an enlarged handle.

6. The apparatus of claim 1, further comprising:
a glass photovoltaic panel mounted to the photovoltaic frame; and
an elongated structural strut to which the fastener is fastened;
the panel and frame hiding at least a majority of the fastener when it is fastened to the strut.

7. The apparatus of claim 1, wherein the tool is a flat bladed screwdriver.

8. The apparatus of claim 1, wherein rotation of the section of the tool about a centerline tool axis disengages the tongue from the frame.

9. The apparatus of claim 1, wherein up/down levering of the tool section disengages the tongue from the frame.

10. The apparatus of claim 1, wherein the entire fastener is bent from a single piece metallic sheet and includes flexible snap-in wings.

11. The apparatus of claim 1, wherein the tool section is inserted into an open end of the fastener in a lateral direction substantially parallel to the frame segment when the tool contacts the tongue, and the tool includes an elongated shaft and the tool section is substantially flat.

12. A photovoltaic fastener removal apparatus comprising:
(a) an elongated structural strut including an opening therein;
(b) a photovoltaic frame-receiving fastener including a flexible wing which snaps into the opening in the strut to secure the fastener to the strut; and
(c) a tool including jaws which move toward and away from each other upon movement of a handle;
(d) the handle being located on a backside of the strut, opposite the strut opening, while the jaws inwardly compress the wing, to allow the fastener to be removed from the strut without damage.

13. The apparatus of claim 12, wherein the fastener further comprises a second flexible wing, the wings being spaced apart from each other when snapped into the strut, and the jaws pushing both wings toward each other during removal.

14. The apparatus of claim 12, wherein middle sections of the jaws of the tool are spaced apart from each other by at least three inches when in a closed position.

15. The apparatus of claim 12, wherein the fastener further comprises a finger extending from the wing proud of an outer surface of the strut when the fastener is attached to the strut, the finger having a lateral dimension less than that of the wing, and one of the jaws of the tool directly compressing against the finger to allow removal of the fastener from the strut.

16. The apparatus of claim 12, wherein the handle of the tool includes at least two handles which are coupled together by at least one pivot to open and close the jaws by moving the handles.

17. The apparatus of claim 12, wherein the handle of the tool includes a primary handle, an adjuster, a lock and a release handle.

18. The apparatus of claim 12, wherein each jaw of the tool includes a substantially flat tip with a thickness less than ¼ that of a nominal jaw thickness, the tips of the tool are the thinnest portions of the jaws, the tips of the tool inwardly face each other when in a closed position, and the tips of the tool directly contact the fastener during removal.

19. The apparatus of claim 12, wherein the entire fastener is bent from a single piece metallic sheet.

20. The apparatus of claim 12, further comprising:
a glass photovoltaic panel; and
a frame mounted to the panel;
the frame removeably engaging within an elongated slot of the fastener; and
the panel and frame hiding at least a majority of the fastener when it is fastened to the strut; and
the tool surrounding a cross-sectional majority of the strut when compressing the wing of the fastener during removal.

21. The apparatus of claim 12, wherein the strut is mounted onto a building.

22. The apparatus of claim 12, wherein the tool compresses a member of the fastener entirely outside of the strut, a supplemental handle is on an opposite side of the strut from the member of the fastener during fastener removal, and a locking cam assists in locking the tool in a clamping position during fastener removal.

23. A photovoltaic fastener removal apparatus comprising:
(a) an elongated strut including an opening therein;
(b) a photovoltaic frame-receiving fastener including a flexible wing which snaps into the opening in the strut to secure the fastener to the strut; and
(c) a tool including jaws which move toward and away from each other;
(d) the fastener further comprising a finger extending from the wing external to an outer surface of the strut when the fastener is attached to the strut, and one of the jaws of the tool directly compressing against the finger external to the strut to allow removal of the fastener from the strut.

24. The apparatus of claim 23, wherein the fastener further comprises a second flexible wing, the wings being spaced apart from each other when snapped into the strut, and the jaws pushing both wings toward each other during removal.

25. The apparatus of claim 23, wherein middle sections of the jaws of the tool are spaced apart from each other by at least three inches when in a closed position so as to substantially surround a section of the strut during fastener removal.

26. The apparatus of claim 23, wherein the tool further comprises multiple handles coupled together by at least one pivot to open and close the jaws due to relative movement of the handles.

27. The apparatus of claim 23, wherein each of the jaws of the tool has a substantially C-shape with a step adjacent to a distal end including a tip, and each tip of the tool is substantially flat and thin, and each tip of the tool contacts against the corresponding finger of the fastener to push the wing toward a centerline of the fastener.

28. The apparatus of claim 23, further comprising:
a glass photovoltaic panel; and
a frame mounted to the panel; and
the frame removeably engaging within an elongated slot of the fastener;
the panel and frame hiding at least a majority of the fastener when it is fastened to the strut, and handles of the tool are located on an opposite side of the strut from the finger of the fastener during fastener removal.

29. The apparatus of claim 23, wherein the tool further comprises a lock to hold the jaws in a clamping position during fastener removal.

30. A fastener removal tool comprising:
manually actuable handles;
jaws pivotally coupled together and moveable by actuation of the handles, middle sections of the jaws being spaced away from each other by at least three inches in all jaw movement positions; and
fastener-engageable end tips of the jaws facing each other and each tip defining a substantially flat surface elongated substantially perpendicular to an elongation direction of the handles when in a clamping position;
the tips each having a longitudinal thickness dimension less than ¼ that of a middle section of the associated jaw.

31. The tool of claim 30, wherein the handles are pivotal handles.

32. The tool of claim 30, wherein the handles are locking handles to hold the jaws in the clamping position during fastener removal.

33. The tool of claim 30, wherein the jaws define a substantially closed shape around an open center, with a middle area of the jaws being spaced apart by at least three inches, when in the clamping position.

34. The tool of claim 30, wherein the end tips cause compression of snap-in wings of a photovoltaic frame fastener to allow its removal from an elongated structural strut.

35. A method for removing a photovoltaic fastener from a structural rail, the method comprising:
(a) moving a first handle relative to a second handle of a removal tool;
(b) directly contacting ends of a removal tool against projections of the photovoltaic fastener externally extending from the rail when the fastener is attached to the rail;
(c) inwardly moving snap-in members of the fastener toward each other in response to step (b); and
(d) extracting the fastener from an opening in the rail in a primarily linear manner substantially perpendicular to an elongated direction of the rail.

36. The method of claim 35, further comprising moving the handles of the tool adjacent a backside of the rail substantially opposite to where a photovoltaic frame attaches to the fastener.

37. The method of claim 35, further comprising substantially surrounding a section of the rail with the tool while inwardly compressing the snap-in members, which are flexible wings.

38. The method of claim 35, further comprising detaching a photovoltaic frame from the fastener and detaching the fastener from the rail without disengating any threaded fasteners.

39. A method for removing a photovoltaic frame from a fastener, the method comprising:
(a) inserting a tool into the fastener;
(b) flexing a tongue of the fastener away from a section of the photovoltaic frame secured to the tongue, by movement of the tool; and
(c) removing the frame from the fastener, in response to step (b).

40. The method of claim 39, wherein the fastener further comprises an edge of the tongue including substantially pointed formations spaced apart by a central valley, and the formations scoring the frame when engaged, further comprising placing an end of the tool between the valley of the tongue and the section of the frame before the flexing of the tongue.

41. The method of claim 39, wherein the tongue is entirely inwardly spaced from all external edges of the fastener, further comprising rotating a portion of the tool between spaced apart side walls of the fastener during the flexing of the tongue, which is also between the side walls.

42. The method of claim 39, further comprising:
a glass photovoltaic panel mounted to the photovoltaic frame, and linearly sliding the frame out of an elongated slot of the fastener which is directly above a snap-in wing; and
an elongated structural strut, and removing the fastener from the strut in a reuseable and nondestructive manner; and
hiding at least a majority of the fastener by the panel and frame when it is fastened to the strut.

43. The method of claim 39, wherein the tool is a screwdriver with a flat blade causing the flexing of the tongue.

44. The method of claim 39, further comprising rotation of the tool about its centerline tool axis pushing the tongue away from the section of the frame.

45. The method of claim 39, further comprising up/down levering of the tool pushing the tongue away from the section of the frame.
